(19) United States
(12) Patent Application Publication
(10) Pub. No.: US 2026/0010915 A1
(43) Pub. Date: Jan. 8, 2026

(54) METHOD AND SYSTEM FOR MANAGING PRODUCT CERTIFICATION

(71) Applicant: InspiRD, Inc., Mission Viejo, CA (US)

(72) Inventor: SANDEEP MEHTA, Redondo Beach, CA (US)

(73) Assignee: InspiRD, Inc., Mission Viejo, CA (US)

(21) Appl. No.: 19/328,208

(22) Filed: Sep. 14, 2025

Related U.S. Application Data
(63) Continuation-in-part of application No. 15/930,433, filed on May 12, 2020.

(51) Int. Cl. G06Q 30/018; G06Q 10/0637

(52) U.S. Cl. CPC G06Q 30/018; G06Q 10/0637

(57) ABSTRACT

A method includes creating a certification argument with one or more certification goals; linking the one or more certification goals to one or more evidences that support the one or more certification goals; linking the one or more evidences to one or more rationales that demonstrate a sufficiency of the one or more evidences; linking one or more contexts, for the one or more certification goals, to the certification argument; determining one or more relationships between the one or more certification goals, the one or more evidences, the one or more rationales, and the one or more contexts; and evaluating a certification effort with the certification argument where at least one of creating the certification argument, linking the one or more certification goals, linking the one or more evidences, linking the one or more contexts, determining the one or more relationships, and evaluating the certification argument by an automated processor.

### CROSS REFERENCE TO PRIOR APPLICATION

This application is a continuation-in-part of U.S. patent application Ser. No. 15/930,433, entitled as “METHOD AND SYSTEM FOR MANAGING PRODUCT CERTIFICATION”, filed May 12, 2020, which is incorporated by reference in its entirety.

### FIELD OF THE INVENTION

The disclosed subject matter relates generally to the field of regulatory approvals and certifications for marketing and selling products.

### BACKGROUND

In an increasingly global economy, there is increasing competition for product sales. To survive in such an environment, organizations need to deliver new innovative products to market. Regulatory approvals are often required before organizations can deliver products to market and generate sales. These regulatory approvals are also referred to as certifications.

Certification requires organizations to prove that a product's performance and safety comply with applicable regulations. Any modifications to a certified product frequently require recertification. Certification efforts are complex because of multiple interdependencies across product elements, complex regulatory criteria, and ongoing overlapping certification efforts.

Historically, certification has been a document-centric effort due to these complexities. Document-centric approaches tend to be error-prone and not easily reproducible. Furthermore, these approaches are subject to confirmation bias, cognitive bias, and sufficiency challenges. Failure to accurately estimate and manage the costs of certification efforts can lead to substantial delays and severely affect product availability.

Large-scale engineering and manufacturing projects frequently require compliance with numerous regulatory frameworks before products can be released to market. For instance, certification requirements apply at multiple levels in industries such as aerospace, construction, and transportation, from entire assemblies to individual components. Each requirement may depend on a combination of technical specifications, safety regulations, and performance criteria. The scope and complexity of these interdependent rules has grown substantially with advances in product technology, regulatory oversight, and international standards.

Issues arise when a modification to even a single component can affect the certification status of related components or assemblies. For example, a wing for a commercial aircraft may comprise thousands of parts. Changing one part's material, geometry, or performance characteristic can invalidate existing certifications because of dependencies between design elements, manufacturing processes, and compliance criteria. Tracking and assessing these dependencies is not straightforward; certification rules often cross-reference other regulations, and those relationships can span multiple engineering disciplines, regulatory bodies, and document formats.

Traditional methods for managing certification are inadequate in this environment. Certification documentation is frequently scattered across engineering drawings, test reports, simulation outputs, and regulatory documents in various formats. Identifying the affected requirements, determining the impact of a design change, and producing the necessary evidence for recertification is time-consuming and error-prone. The complexity of modern engineering systems and the scale of the related certification data make it infeasible to perform this analysis manually or with generic office productivity software.

An efficient and accurate solution capable of ingesting, structuring, and analyzing large volumes of interdependent certification data is needed.

### SUMMARY

The disclosed subject matter relates to a computer-implemented method, a computer-program product, and a computer system for generating and evaluating a certification argument with one or more certification goals. The approach addresses large projects with many interdependent parts. Certification work becomes more feasible by structuring information and reducing manual review.

An implementation may identify evidence, rationales, and contexts from engineering and regulatory sources and link them into a certification argument. The system may determine relationships among certification goals, evidence, rationales, and contexts, including dependencies between certification goals. The system may evaluate a certification effort using the certification argument and apply dependency constraints so that a goal is not marked complete until related goals are satisfied. An automated processor may perform one or more steps. The automated processor may parse documents, build linkages using classifiers, topic modeling, or knowledge graphs, and update the certification argument without human input. A human reviewer may intervene at any point.

### BRIEF DESCRIPTION OF DRAWINGS

The following detailed description, given by way of example and not intended to limit the disclosed subject matter solely thereto, will best be appreciated in conjunction with the accompanying drawings, in which:

FIG. 1 is an illustration of a process of generating certification arguments by the prior art.

FIG. 2 is an illustration of a certification argument and its elements in accordance with exemplary embodiments.

FIG. 3 is a flow diagram illustrating a method to structure and capture certification arguments, in accordance with an embodiment of the disclosed subject matter.

FIG. 4 is an illustration of a method for managing certification efforts, in accordance with an embodiment of the disclosed subject matter.

FIG. 5 is a schematic representation of the certification management system, in accordance with exemplary embodiments.

FIG. 6 depicts a block diagram representing the connector.

FIG. 7 is a block diagram representing the hardware components of the regulatory approval system, in accordance with the exemplary embodiments.

FIG. 8 illustrates a schematic that may be used in an embodiment of the certification management system.

FIG. 9 is a flow diagram of a computer-implemented method to certify a product or service.

FIG. 10 is a flow diagram of a process to modify a certification argument in the certification management system.

FIG. 11 is an illustration of an AI processor processing a source document into a computer-readable format.

FIG. 12 is a flow diagram of a process for certifying a product or service.

The drawings are merely schematic representations, not intended to portray specific parameters of the disclosed subject matter. The drawings are intended to depict only typical embodiments of the disclosed subject matter. In the drawings, the numbering represents similar elements.

### DETAILED DESCRIPTION OF DRAWINGS

Regulatory approvals or certifications are required for market access for enterprises in many industries, such as aerospace, healthcare, automotive, and life sciences. Most modern products have low probabilities of failure, and it is impractical to demonstrate product safety through testing alone. Hence, most regulatory approvals or certifications require building a certification argument that the product will safely perform its intended function while complying with applicable regulations.

The certification management system makes a task previously impractical in large projects possible. A single modification to a component can be analyzed for its effect on all related certifications, including the certification of the component itself. That analysis can be performed even when the component is part of an assembly with thousands of parts. The system evaluates the certification argument, determines all dependent relationships, and identifies all impacted evidence. The work that once required weeks or months of manual review can be completed in a fraction of the time.

The system also makes evaluating multiple design changes in the same project cycle feasible. Users can introduce several modifications to different components and determine the combined effect on the overall certification. The automated evaluation can be repeated as changes occur, making running an iterative design process possible without losing track of certification requirements. The same capability also applies when changes occur late in the design phase, when manual review is unavailable.

An AI processor can locate certification goals, evidence, rationale, tasks, and contexts across various documents such as regulations, laws, corporate charts, and engineering documents and schematics. The AI processor can scan technical drawings, test results, regulatory documents, and specifications in varied formats. The processor converts the identified elements into a structured form to link them to the certification argument.

The AI processor can use classifiers to group related certification elements. A classifier can be trained to recognize specific categories of evidence or types of regulatory rationale. The processor can then place new data into the correct category without manual review.

For example, the AI processor can apply topic modeling to discover related elements based on the language and concepts in the documents. Topic modeling identifies patterns of words that occur together and infers subject matter from them. The processor can use the identified subjects to suggest relationships between certification goals and the evidence or rationale that supports them.

In another example, the AI processor can generate a knowledge graph of certification elements. A knowledge graph represents each element as a node and each relationship as a connection between nodes. The knowledge graph structure allows traversing all dependencies starting from any element. A knowledge graph can also be updated as new data is added, keeping the representation current throughout the project.

Entities and relationships can be stored in Unified Modeling Language (UML) or Systems Modeling Language (SysML) formats. UML and SysML are standardized diagramming languages used in engineering to describe system structures and interactions. Accordingly, data can be integrated with existing engineering design tools.

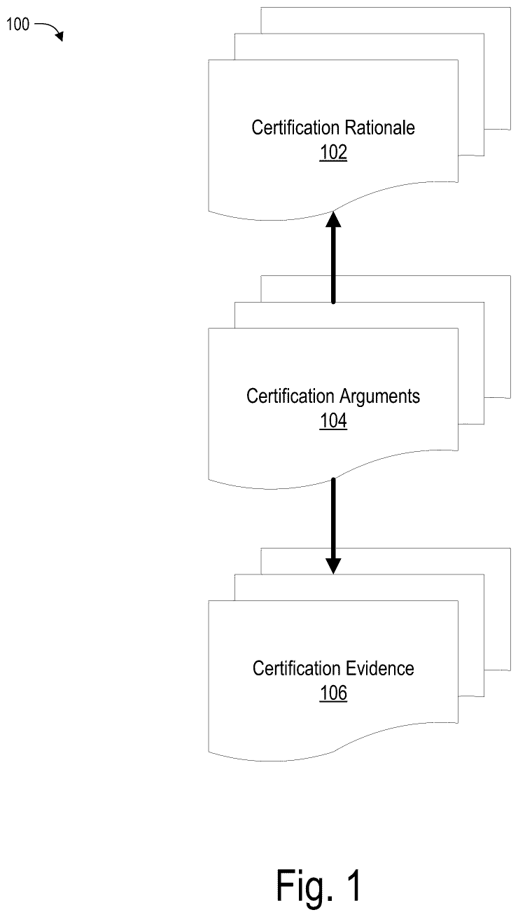

FIG. 1 illustrates a method 100 for building these certification arguments 104 in accordance with the prior art. Certification requires generating evidence 106 that demonstrates that the applicable certification rationale 102 is satisfied.

Many different regulations may apply to any product: product use-related regulations, product components and materials-related regulations, engineering processes-related regulations, manufacturing processes-related regulations, testing and validation-related regulations, packaging and shipping-related regulations, etc. Each regulatory criterion becomes a certification rationale 102 for product certification when sufficient evidence 106 is produced to prove that the criteria has been satisfied. Many engineering documents and test reports are produced as evidence 106. Other documents are produced to make the certification arguments 104 to describe how the provided evidence is sufficient to demonstrate compliance with the certification rationale 102.

All document-centric approaches can become inaccurate and subject to psychological biases. Cognitive bias occurs when organizations do not explore all the potential impacts of modification because the information is hard to track or manage in documents. Confirmation bias occurs when teams focus on information confirming that a modification is safe because they cannot analyze and check large documents. Sufficiency issues arise when many documents make the certification effort superficial, mechanistic, unverifiable, or incomplete.

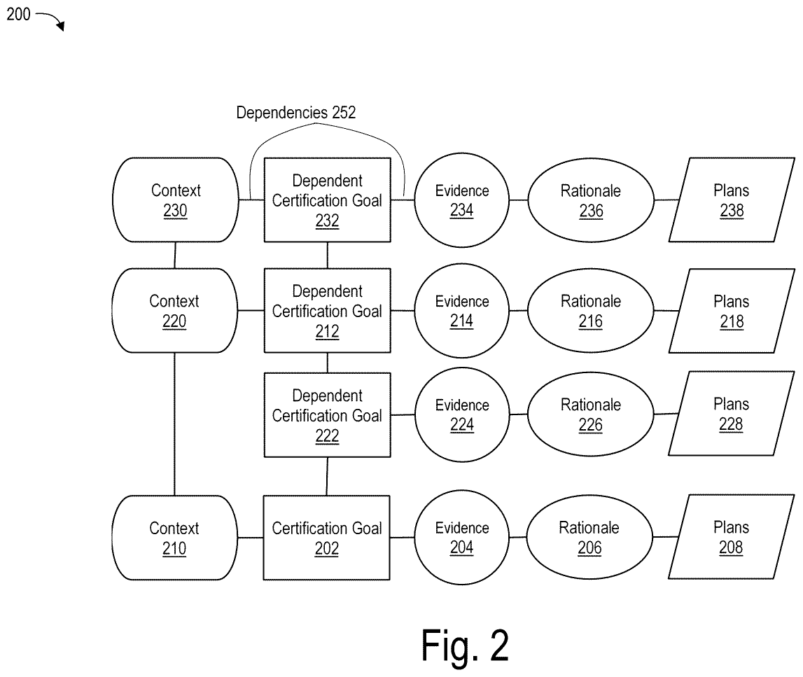

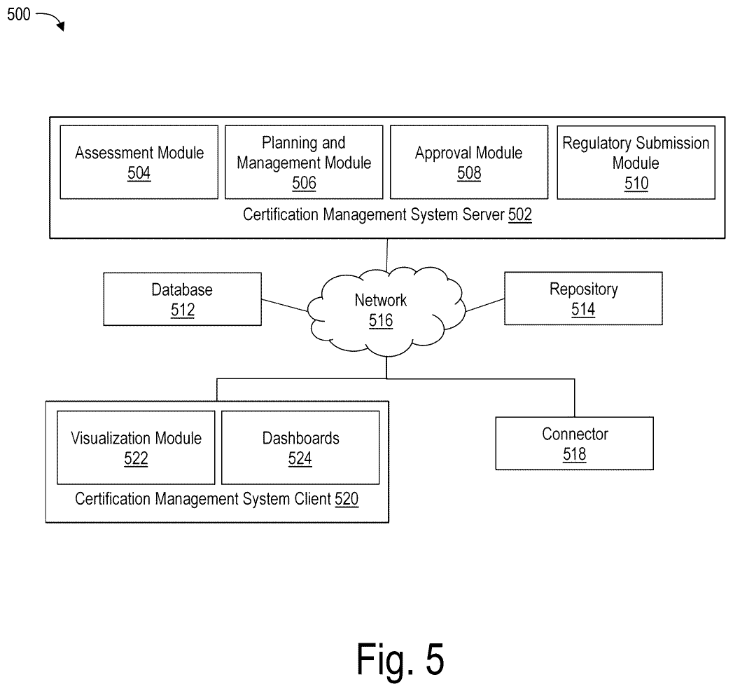

As described below, the certification method (FIG. 2-4) and system (FIG. 5) can digitize the certification efforts, visualize them, efficiently manage them, and reduce the cost required to get products to market.

FIG. 2 depicts a method 200, in accordance with embodiments of the disclosed subject matter, to digitize and visualize certification efforts. Certification Goals 202, 212, 222, and 232 show objectives for certification. These objectives can be of many different types, such as Performance, Safety, and Compliance. In an exemplary embodiment, certification goals may be requirements or specifications for a product element. In another exemplary embodiment, certification goals may be risks or safety criteria for a product element. In yet another exemplary embodiment, certification goals may be regulatory compliance criteria for the product.

Evidence 204, 214, 224, and 234 blocks represent evidence that the certification goals have been achieved. In an exemplary embodiment of the disclosed subject matter, the evidence block may be a link to a test report demonstrating certification goal satisfaction. In another embodiment, the evidence block may be linked to an engineering analysis document that demonstrates that the certification goal has been achieved. In yet another embodiment, the evidence block may be a link to an engineering analytics tool demonstrating certification goal satisfaction.

Rationale 206, 216, 226, and 236 blocks represent the corresponding rationale or regulatory criteria that describe why the presented evidence is sufficient to demonstrate that the certification goals have been achieved. In an exemplary embodiment of the disclosed subject matter, the rationale blocks may link to regulatory documents, clauses, or sentences within them. The rationale blocks may link to engineering standards documents in another exemplary embodiment. In yet another embodiment of the disclosed subject matter, the rationale blocks may point to internal engineering policies and documents.

Plans 208, 218, 228, and 238 represent the tasks and schedules for generating the evidences 204, 214, 224 and 234 respectively. In an exemplary embodiment of the disclosed subject matter, plans may be represented as task schedules or Gantt charts. In another embodiment, plans may be represented as agile development issues.

Context 210, 220, and 230 blocks provide a structured perspective for goals, evidence, rationale and plans. In an exemplary embodiment of the disclosed subject matter, context blocks may represent categories such as product components, technologies, and manufacturing processes. In another exemplary embodiment, context blocks may represent a hierarchy of projects and subprojects for achieving certification goals.

Various blocks are connected by dependency lines 252. These lines indicate relationships between different elements of a certification effort. In an exemplary embodiment, dependency lines may represent parent-child relationship between context 210, 220, 230 blocks. In another embodiment, dependency lines may represent relationship between certification goals, its evidence, its rationale, its plan and context. In yet another embodiment, the dependency lines may represent relationships and links between certification goals 202, 212, 222, and 232.

Together, elements of the method 200 enable digitization, visualization, storage and management of complex certification efforts. Certification goals may communicate objectives of the certification effort and dependency lines 252 communicate relationships between them. In an exemplary embodiment of the disclosed subject matter, these blocks and dependencies can be associated with discrete database elements and stored in a database.

While FIG. 2 shows a small number of blocks to illustrate the method 200, the method 200 is scalable to represent any number of blocks and certification arguments of any complexity. The method 200 formalizes and visualizes complex certification arguments 104 and effectively addresses all the issues of a document-centric approach. It represents and uniquely identifies different certification rationales 102 and related evidence.

Furthermore, the method 200 clearly identifies certification goals and ties them to context. In an example embodiment, the hierarchical tree structure of context simplifies navigation to and access of any certification goals, their rationale and related evidence. Integration of plans in the method 200 simplifies management of certification efforts. In another example embodiment, blocks in the method 200 can link related detailed documents, reports and digital files simplifying access to and providing a navigable index for the complex certification documentation. These documents may be in an electronic format such as HTML, Adobe PDF, Microsoft Word, Microsoft Excel, Plain Text, JSON, or XML, among others.

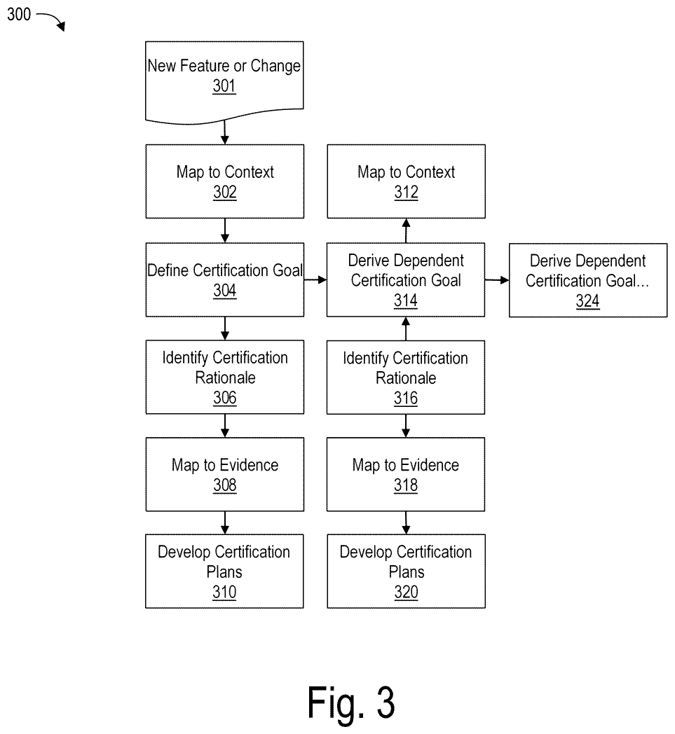

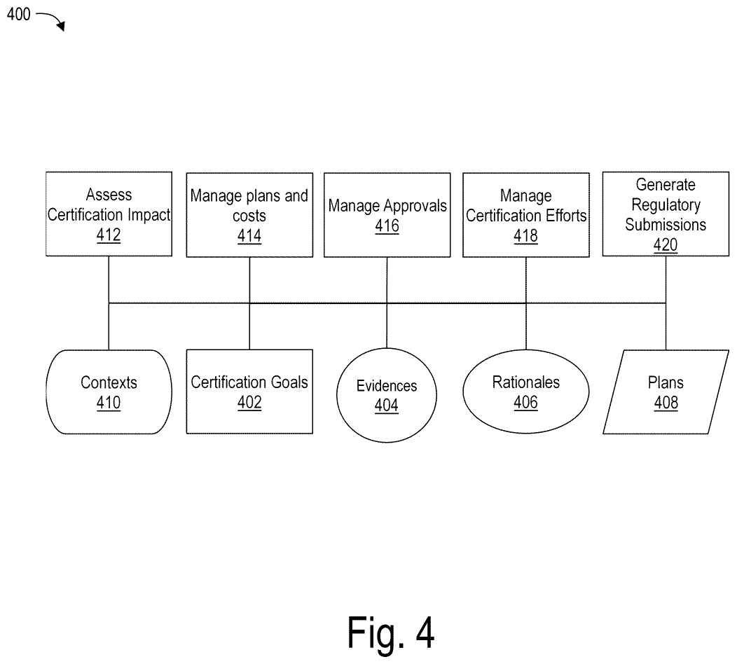

FIG. 3 depicts a method 300 for building certification arguments and managing certification efforts in accordance with the method 200. FIG. 4 depicts a method 400 for storing and managing certification information.

In an exemplary embodiment of the disclosed subject matter, a new feature or change to an existing feature 301 is mapped to a context 302. These context 410 blocks can be represented as a block in a visualization and a database element can be created to store the contexts. Blocks 210, 220, 230 are examples of context blocks.

Certification goals are defined for the feature 301. These certification goals 402 can be represented as blocks in a visualization and a database element can be created to store the certification goal. Blocks 202, 212, 222 and 232 are examples of certification goals.

Certification rationale is identified 306 for each certification goal. These rationales 406 can be represented as a block in the visualization and a database element can be created to store the rationale. Blocks 206, 216, 226, and 236 are examples of certification rationale.

Evidence to demonstrate that a certification goal is achieved is mapped 308. These evidences 404 can be represented as blocks in a visualization and database elements can be created to store them. Blocks 204, 214, 224, and 234 are examples of evidence.

Plans to generate the evidence to demonstrate certification goals are developed 310. These plans 408 can be represented as blocks in the visualization and database elements can be created to store the evidence. Blocks 208, 218, 228, and 238 are examples of plans.

In an exemplary embodiment, dependent certification goals can be derived at 314 from any certification goal 304. These certification goals can be mapped to context 312. Similarly, rationale 316 can be identified for the goal at 314 and related evidence can be mapped 318. Plans to gather the evidence can also be developed 320. The process can then be repeated as necessary for further dependent certification goals 324. All dependent certification goals, rationales, evidences, plans and context can be stored in database as shown in FIG. 4. While the steps in the method 300 are described sequentially, they may occur in different order or occur asynchronously.

In an exemplary embodiment, the visualizations using blocks and associated database elements: certification goals 402, evidences 404, rationales 406, plans 408 and contexts 410 can be used to assess at step 412 any complex certification effort. Team members can easily navigate to any certification goal and access data distributed across organizational boundaries. Certification goals 402 for any context 410 element can be located and their associated rationale 406 and evidence 404 can be accessed.

In an exemplary embodiment, plans 408 along with certification goals 402 and context 410 allow managers to easily evaluate a status of complex certification efforts. Teams are able to manage, at step 414, plans and costs across locations and organizations.

Team members sometimes sign or approve certification goals indicating that the goal has been achieved. Contexts are sometimes signed or approved to indicate that all corresponding goals have been achieved. In another exemplary embodiment, these approvals can be managed at step 416 along with the corresponding certification goals 402 and contexts 410. Overall management of complex certification efforts 418 can be achieved by integrating steps 412, 414 and 416.

In yet another embodiment, documents for regulatory submissions may be generated 420 from blocks: certification goals 402, evidences 404, rationales 406, plans 408 and contexts 410. These documents may be in an electronic format such as HTML, Adobe PDF, Microsoft Word, Microsoft Excel, Plain Text, JSON, or XML, among others.

In accordance with exemplary embodiments, FIG. 5 describes a computer program product, and certification management system 500 for managing certification. In the example embodiment, the certification management system 500 may include one or more certification management system servers 502, one or more certification management system clients 520, one or more databases 512 and one or more document repositories 514, all interconnected via a network 516.

In the example embodiment, the certification management system client 520 may act as a client in a client-server relationship and may be a software and/or hardware application capable of communicating with and providing a user interface to interact with a certification management system server 502 via the network 516. In another embodiment, the certification management system client 520 may run in a web browser.

In an example embodiment, the Databases 512 may be a single database software instance. In other embodiments, multiple database software instances may be used.

In the example embodiment, the certification management system 500 may contain one or more document repositories 514. A document repository may contain one or more documents such as regulatory documents, internal technical documents, intellectual property documents, technical papers, or other technical documents, among others. These documents may be in an electronic format such as HTML, Adobe PDF, Microsoft Word, Microsoft Excel, Plain Text, JSON, or XML.

In the example embodiment, the certification management system server 502 may contain one or more modules providing different capabilities. In accordance with exemplary embodiments, the certification management system server 502 may contain an assessment module 504, a planning and management module 506, an Approval Module 508, and a Regulatory Submission Module 510.

In the example embodiment, an assessment module 504 may implement the method 200 for building a certification argument. In another embodiment, the assessment module 504 may implement the method 300 to generate elements of the certification argument. The assessment module 504 may store, access and modify certification related data into a database 512. In another embodiment, the assessment module 504 may store, access and modify documents in the document repository 514.

In an example embodiment, a planning and management module 506 may implement the method at step 414 for managing plans and costs of a certification effort. In another embodiment, the planning and management module 506 may access, store and modify planning data in the database 512. In another embodiment, the planning and management module 506 may store, access, and modify documents in the document repository 514.

In another example embodiment, an approval module 508 may implement the method at step 416 for managing approvals for various elements of a certification effort. In another embodiment, the approval module 508 may access, store and modify approval data in the database 512. In another embodiment, the planning and management module 506 may store, access, and modify documents in the document repository 514.

In an example embodiment, a regulatory submission module 510 may implement the method at step 420 for generating regulatory submission documents. In another embodiment, the regulatory submission module 510 may access, store and modify regulatory submission data in the database 512. In another embodiment, the regulatory submission module 510 may store, access, and modify documents in the document repository 514.

In an example embodiment, the certification management system client 520 may include a Visualization Module 522 that generates structured visualizations of the certification effort in accordance with the method 200. The visualization module 522 may also enable users to provide data for certification in accordance with method 300. The visualization module may further allow users to access certification data and documents.

In an example embodiment, the certification management system client 520 may include Dashboards 524 to help the manager analyze and control certification efforts. These dashboards may implement methods for steps 414 and 418.

In an example embodiment, the certification management system server 502 may utilize the dependencies and relationships in the database to automatically send notifications to team members responsible for any certification goals 202, evidences 204, rationale 206, plans 208 or context 210 for changes to any connected element. These notifications simplify change coordination and reduce the possibility of errors. For example, notifications may be sent when the status of a certification goal changes. The team member recipients of the notifications may be selected based on the relationships of the changed certification goal.

In another example embodiment, the certification management system 500 may include a connector 518 to connect the certification management system 500 to other certification and engineering tools. In other embodiments, the connector 518 may include capabilities to launch other applications and exchange data with them.

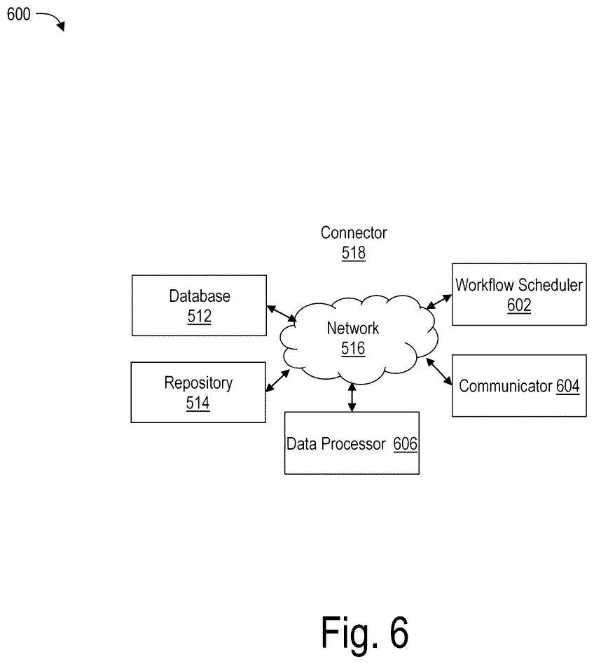

In another example embodiment, the certification management system 500 may include a connector 518 to connect the certification management system 500 to other certification and engineering tools. In accordance with exemplary embodiments, FIG. 6 depicts a block diagram 600 representing the connector 518.

In exemplary embodiments, the connector 518 may include capabilities to launch other applications and exchange data with them. The applications launched may execute engineering models numerically representing elements of a product and assemble such models. The execution of these models will numerically generate evidence (404) to support certification.

The connector may include a communicator 604 to facilitate data transfer across models located in document repositories 514. The communicator may be supported by a Workflow Scheduler 602. The workflow scheduler may manage execution of assemblies of models by accessing from the database 512: rationales 406, certification goals 402, and dependencies 253. Document repositories 514 may include engineering artifacts such as models and engineering tools. Results obtained from the execution of different models may be fused together for further analysis and usage in the Data Processor 606. The network 516 may connect the communicator 604, workflow scheduler 602 and data processor 606 with databases 512 and document repositories 514.

In an example embodiment, the workflow scheduler 602 may represent the models to be executed as directed acyclic graphs. The workflow scheduler may schedule model assembly execution, maintain data provenance, and capture execution metadata. It may run workflows concurrently or serially as appropriate. The workflow scheduler may support execution of models in diverse computing environments including native execution as well as cloud-computing infrastructure.

The workflow schedule may trigger tools based on multiple criteria such as schedule, events, or input data availability. The workflow scheduler may work with the communicator to ensure all collected data is retrievable on demand. In another embodiment, the workflow scheduler may integrate the ability to kill, suspend, and resume any part of execution. The workflow scheduler may save and reuse model assembly compositions in editable formats such as XML.

In an exemplary embodiment, the communicator 604 may be a messaging platform permitting synchronous or asynchronous data transmission across models. In an exemplary embodiment, the messaging platform may include polling frameworks. In other embodiments, the communicator may use message queuing and brokering approaches. In yet other embodiments, the communicator may use a streaming platform.

In other embodiments, the communicator can include means of transferring data with guaranteed quality. The communicator may be idempotent: ensuring correct data is transmitted only once regardless of the number or timing of data calls. The communicator can implement caching mechanisms to facilitate fault-tolerant communications. Security and access control may be built into the communicator for additional functionality. The communicator may include data transfer frameworks that ensure fault-tolerance for network outages, data errors, application crashes, or computation infrastructure issues.

In an exemplary embodiment, the data processor 606 may include a data translator to translate data formats between multiple tools. In other embodiments, the data fusion macros and filters may be integrated into the data processor. In yet another embodiment, the data processor may include algorithms to summarize and visualize results.

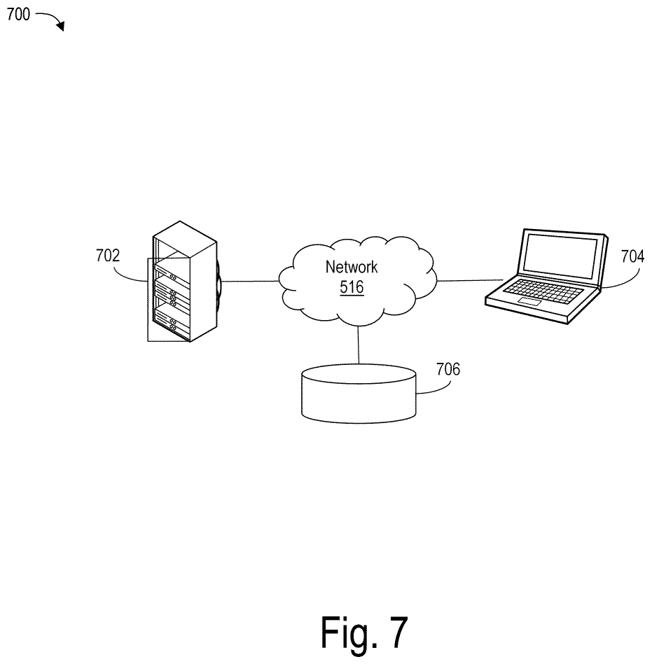

FIG. 7 depicts a block diagram 700 of the hardware components of the certification management system. In the example embodiment, the network 516 may be a communication channel capable of transferring data between connected devices. In the example embodiment, the network 516 is the Internet, representing a worldwide collection of networks and gateways to support communications between devices connected to the Internet.

Moreover, the network 516 may include, for example, wired, wireless, and/or fiber optic connections, which may be implemented as an intranet network, a local area network (LAN), a wide area network (WAN), or a combination thereof. In further embodiments, the network 516 may be a Bluetooth network, a WiFi network, or a combination thereof. In general, the network 516 can be any combination of connections and protocols that will support communications between connected devices.

In the example embodiment, server device 702 may include the certification management system server 502 and may be an enterprise server, a server, a virtual device, a laptop computer, a notebook, a tablet computer, a netbook computer, a personal computer (PC), a desktop computer, a personal digital assistant (PDA), a smart phone, a mobile phone, or any other electronic device or computing system capable of receiving and sending data to and from other computing devices.

In the example embodiment, the client device 704 may include certification management system client 520 and may be a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices.

In the example embodiment, the computer storage medium 706 provides storage capability for the certification management system 500. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination therein. A non-exhaustive list of more specific examples of the computer readable storage medium includes the following: a portable computer diskette, a hard disk, a random access memory (RAM), a read-only memory (ROM), an erasable programmable read-only memory (EPROM), a static random access memory (SRAM), a portable compact disc read-only memory (CD-ROM), a digital versatile disk (DVD), a memory stick, or a Flash Memory device (SD Card). While the computer storage medium 706 is shown as a single device, in other embodiments, the storage can be a cluster or plurality of storage media, working together or working separately.

While the server device 702 and client device 704 are shown as single devices, in other embodiments, they may be comprised of a cluster or plurality of computing devices, working together or working separately. The server device 702 and client device 704 may contain one or more processors, such as microprocessors that execute program instructions, and means to access storage devices such as the computer storage medium 706 to load program instructions.

While in the example embodiment, programming and data of the disclosed subject matter are stored and accessed remotely across server device 702, client device 704 and computer storage medium 706 via the network 516; in other embodiments, programming and data of the disclosed subject matter may be stored or executed locally on as few as one physical computing device or amongst other computing devices than those depicted.

In exemplary embodiments, the certification management system 500 may be deployed using a cloud computing model. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Hence, in the exemplary embodiment, the server device 702 and the computer storage medium 706 may be provided through cloud computing service.

The database 512 may be stored in and accessed from the computer readable storage media 706. The document repository 514 data may be stored in and accessed from the computer storage medium 706.

The certification management system 500 may be provided using Software as a Service (SaaS): the capability provided to the consumer is to use the provider's applications running on a cloud infrastructure. The applications are accessible from various client devices through a thin client interface such as a web browser (e.g., web-based email).

The disclosed subject matter may be a system, a method, and/or a computer program product at any possible technical detail level of integration. The computer program product may include a computer readable storage medium (or media) having computer readable program instructions thereon for causing a processor to carry out aspects of the disclosed subject matter.

Computer readable program instructions described herein can be downloaded to respective computing/processing devices (server device 702 and client device 704) from a computer readable storage medium 706 or to an external computer or external storage device via a network 516. Computer readable program instructions for carrying out operations of the disclosed subject matter may be assembler instructions, instruction-set-architecture (ISA) instructions, microcode, firmware instructions, state-setting data, or either source code or object code written in any combination of one or more programming languages such as Java, C++, JavaScript, or Python, among others.

In some embodiments, at least one automated processor may perform at least one of the creating of the certification argument, linking of the one or more certification goals, linking of the one or more evidences, linking of the one or more contexts, linking tasks that can generate the one or more evidences, determining of the one or more relationships, or evaluating of the certification argument. The automated processor may further identify one or more certification goals, evidences, rationales, or contexts without human input.

The automated processor may track approvals of the one or more certification goals in the certification argument. The automated processor may also generate a notification responsive to a change in the certification argument, where one or more recipients for the notification are selected based on the one or more relationships. The automated processor may modify the one or more tasks and their relationships in the certification argument to optimize costs of certification.

The automated processor may assemble one or more engineering models that represent elements of the product or service and execute the one or more engineering models to generate one or more evidences. In some cases, the automated processor may determine, using one or more engineering models, a range of product specifications that will satisfy one or more certification goals of the certification argument. The automated processor may also determine multiple potential modifications or ranges of modifications to one or more elements of the engineering models that would be sufficient to satisfy one or more certification goals. In certain embodiments, the automated processor may further determine ranges of modifications that would satisfy most, but not all, of the certification goals, thereby enabling users to assess partial compliance scenarios.

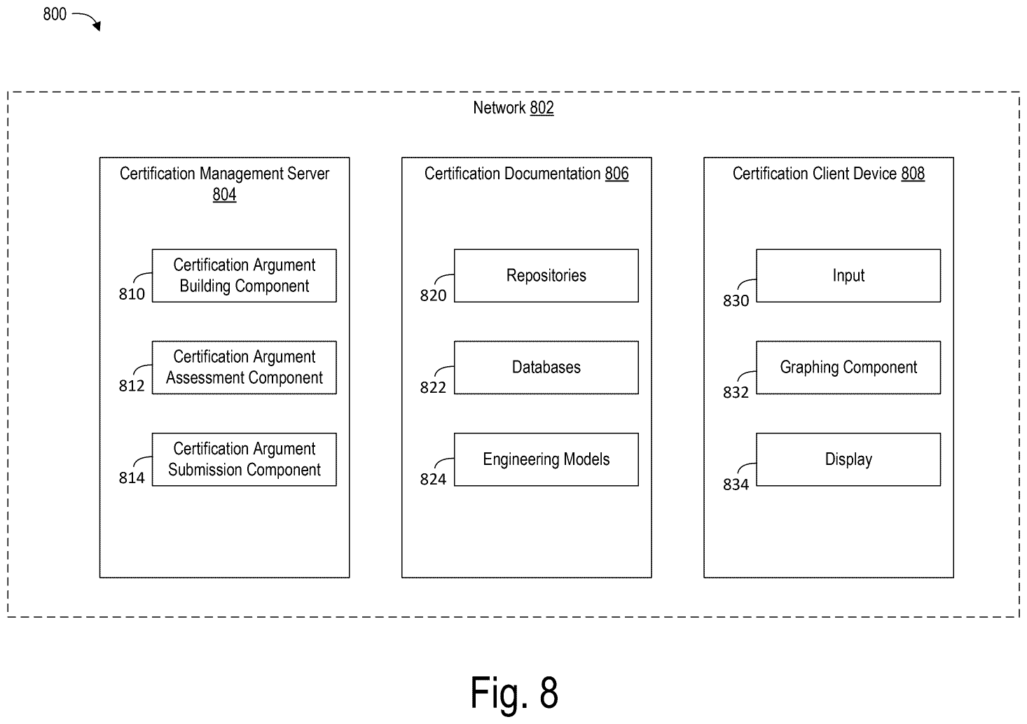

Referring to FIG. 8, FIG. 8 illustrates a schematic that may be used in an embodiment of the certification management system 800. In the exemplary embodiment shown in FIG. 8, the certification management system 800 may be a network 802 that connects a certification management server 804, certification documentation 806, and one or more certification client devices 808. The network 802 may be connected through a single computing system, a co-located computing system, a cloud-based computing system, or the like.

The certification management system 800 can be configured so that each step of the certification process is automated. Automation can include creating certification arguments, identifying certification goals 202, linking evidence 204, associating rationale 206, mapping tasks, and determining contexts 210. The system can also operate with a human in the loop at any stage of the process. A user can review the automated output, oversee decision-making, override specific determinations, and introduce refinements to the certification argument. The option for direct human intervention is available at any part of the process is needed.

The certification management server 804, certification documentation 806, and certification client device 808 of the network 802 may be linked through various connections including a direct wired connection, a wireless connection, and a physically accessible system. In an example of a physically accessible system, the certification documentation 806 exists as paper documents that are scannable. At the request of the certification management server, the paper documents of the certification documentation 806 may be scanned into digital form either through an automated process or manually.

The certification management server 804 performs the functions of creating certification arguments, evaluating the certification arguments, modifying certification arguments, determining impacts of modifications of certification arguments, and generating regulatory submission documents with the certification argument. In various embodiments, the certification management server 804 may include a certification argument building component 810, a certification argument assessment component 812, and a certification argument submission component 814.

Each component of the certification management server 804 can be configured for automated operation. The certification argument building component 810 can automatically generate certification arguments without manual input. Documents can be scanned digitally or processed automatically to extract rules, establish context 210, define certification goals 202, identify relationships, and locate supporting evidence 204. The certification argument submission component 814 can automatically prepare and transmit regulatory submissions once the certification argument is complete. Human-in-the-loop control can be applied to any stage so that a user can review, adjust, or approve automated results.

The certification argument building component 810 may create certification arguments that can be evaluated to determine if one or more certification goals 202 are met. The certification argument building component 810 may generate elements of certification arguments such as certification goals 202, contexts 210, evidence 204, rationales 206, and plans 208.

Relationships between the elements may be determined by the certification argument building component 810. In one example, the relationships between elements may be predefined. In an instance of the example, the predefined relationship may be input as part of the element, such as a certification goal may be predefined to be dependent on another certification goal.

The certification argument building component 810 may execute models that generate elements. For example, the certification argument building component 810 may execute an engineering model 824 to generate an evidence 204 element that may be used to demonstrate that a certification goal has been achieved. In one implementation, an engineering model may generate the evidence that an electrical component is capable of operating at minimum frequency. The certification argument building component 810 may link the generated evidence 204 to a certification goal 202.

The certification argument building component 810 may modify existing certification arguments. For example, if an engineering model 824 is modified, it may generate a new evidence 204 element. The certification argument building component 810 may execute the engineering model to generate the new evidence that replaces one or more evidence 204 elements of a previous engineering model 824. In various embodiments, the certification argument building component 810 may modify one or more tasks and their relationships in the certification argument to optimize costs of certification. For example, the certification argument building component 810 may be programed to determine evidence elements that are redundant, and where they are redundant, eliminate the tasks and associated relationships that generate the redundant evidence.

In an exemplary embodiment, the certification argument building component 810 may execute tasks that generate evidence 204. For example, a task may be to execute an engineering model to generate evidence. The certification argument building component 810 may implement tasks to generate evidence 204 as it creates and modifies a certification argument.

The certification argument building component 810 can automatically generate each of the elements that make up a certification argument. The component can create certification goals 202 by reading and interpreting rules found in regulatory or engineering documents. Those rules can also define the context 210 in which each certification goal 202 is applied. The context 210 is stored in a form that the system can process so that the relationships between certification goals 202, evidence 204, rationale 206, and tasks can be determined.

The certification argument building component 810 can generate one or more tasks to produce evidence 204 for each certification goal 202. The component can link the tasks to the appropriate context 210 and rationale 206. It can also determine relationships between certification goals 202. Relationships may include dependencies where one certification goal 202 is not satisfied unless another certification goal 202 is satisfied.

The certification argument building component 810 can implement AI models to identify and organize certification data. A classifier can be used to detect and categorize certification goals 202, evidence 204, rationale 206, tasks, and context 210 in engineering documents. Topic modeling can be applied to identify recurring patterns in the language of those documents, which can reveal relationships between elements that are not explicitly stated.

A knowledge graph can be used to represent elements as nodes and the relationships between them as edges. A classifier can establish nodes based on engineering documentation. Edges can be created when a relationship is found between two elements. The knowledge graph can then be traversed to locate indirect dependencies between certification goals 202. For example, a certification goal 202 for one part may be connected in the knowledge graph to a certification goal 202 for another part. That connection may show that a change in the first part would require an update to the certification of the second part.

The certification argument building component 810 can operate without human input or can include human-in-the-loop review. In human-in-the-loop operation, a user can inspect and edit any automatically generated element before it is stored or linked. The component can learn from edits made by a user to improve future automated output.

The certification argument assessment component 812 may determine if certification goals 202 in a certification argument are satisfied. In an exemplary embodiment, the certification argument assessment component 812 evaluates rationale 206 elements to determine if certification goals 202 that are linked to the rationale 206 elements are satisfied. In one example, the certification argument assessment component 812 may evaluate a certification goal of a component of a product. A rationale 206 that is linked to the certification goal 202 may direct the certification argument assessment component 812 to evaluate evidence 204 that is linked to the certification goal 202. Based on the evaluation of the evidence 204, the certification argument assessment component 812 may or may not determine that the certification goal 202 is satisfied.

In various embodiments, a certification goal 202 has multiple dependent certification goals 222. The certification argument assessment component 812 may be configured to enjoin the dependent certification goals 222 from certification unless the certification goal 202, for which they are dependent, is satisfied. In one implementation, the certification argument assessment component 812 may evaluate dependent certification goals 222 that do not have a satisfied certification goal 202 for which they are dependent. The certification management server 804 may then flag the dependent certification goal 222 as satisfied/not satisfied with a not satisfied certification goal 202.

The certification argument assessment component 812 can operate in a fully automated mode. The component can evaluate a certification goal 202 without user instruction once relevant data is available. The component can also assess multiple certifications in a single process when the relationships between parts require it. For example, a user may request assessment of a certification goal 202 for a single part, and the component can determine that related certifications for other parts must also be evaluated. All related certifications can then be assessed automatically.

The certification argument assessment component 812 can also initiate assessments without user input. The component can receive regulatory guidelines, engineering schematics, and other technical documents, and then determine which parts or systems require certification. It can perform evaluations for all parts of a product or for a subset of parts based on the available data and detected relationships. The assessments can be stored for later review or used immediately to update the certification argument.

The certification argument submission component 814 prepares documents for regulatory submission. As regulatory submission may have its own regulation associated with it, the proper submission of regulatory documents is aided by the certification argument submission component 814. The certification argument submission component 814 may be configured to prepare regulatory submissions on a timely basis as the submission may be required by a specific date. Further, regulatory submission may be a certification goal 202, for which other certification goals 222 are dependent. The certification argument submission component 814 may prepare regulatory submissions by listing certification goals and with evidence 204 and the rationale 206 for how the evidence 204 satisfies the certification goal 202.

The certification documentation 806 provides data in various forms from which the certification argument is based. Certification documentation 806 may define various elements of certification arguments. For example, the certification documentation 806 may define the certification goals 202, the context 210 of certification goals 202, the evidence 204 of certification goals 202, the rationale 206 to evaluate the evidence 204, and tasks to generate the evidence 204. In an exemplary embodiment, one or more of the various evidence 204 elements of a certification argument may not be found in the certification documentation 806, but generated by executing models by the certification argument building component 810.

The certification argument submission component 814 can determine the format and destination for a regulatory submission without user input. The component can identify the appropriate organization or multiple organizations that require the submission based on the certification goals 202, context 210, and applicable regulations. It can also determine the timing for each submission by determining a regulatory deadline or similar or by selecting an optimal time based on project status. The component can suggest the timing to the user or transmit the submission automatically in the required format to the designated recipients.

In various embodiments, the certification documentation 806 includes repositories 820, databases 822, and engineering models 824. The repositories 820 are one or more document containing devices or the like that may be used to define various elements of a certification argument. The repositories 820 may be digital document holders, physical document holders, or devices that have access to documents.

Documents in repositories 820 may contain data that may be used to create various elements of the certification argument. The data may be manually transmitted from the documents in the repositories to the elements of the certification argument. Alternatively, the data may be automatically transmitted into elements of the certification argument. For example, a program may contain the instructions that, when executed, cause a certification goal to be extracted from a regulatory document. In one implementation where all regulations in a document are preceded by a numeral, a program may instruct a computing device to transmit the sentence after each numeral into a certification goal 202.

The databases 822 may store certification arguments such that the certification arguments can be read and assessed. The various elements of certification arguments including certification goals 202, evidence 204, rationales 206, contexts 210, tasks, and relationships between the elements may be stored in one or more databases 822. The databases 822 may comprise various types of storage including, but not limited to magnetic tape drive, flash memory, and the like. The elements of the certification arguments stored in databases 822 may be assessed by the certification argument assessment component 812 to determine if a product or service has satisfied the certification goals 202 of a certification argument. Additionally, the elements of the databases 822 may be modified by the certification argument building component 810.

The repositories 820 can be processed automatically by AI systems to extract certification data. The AI system can analyze text, tables, diagrams, and metadata within documents stored in the repositories 820. From that analysis, the system can identify context 210 elements that define the scope or category for a certification goal 202. It can also detect certification goals 202, evidence 204, and rationale 206 within the same or related documents.

The AI system can determine linkages between extracted elements by analyzing the content and structure of the documents. For example, a reference within an engineering report to a specific regulation can be linked to the corresponding certification goal 202, with the report itself identified as evidence 204. A procedural document describing how the evidence 204 was generated can be linked as the rationale 206. The linkages can be stored in the databases 822 so that the relationships are preserved and can be used to update the certification argument automatically when the repository content changes.

Engineering models 824 may be physical descriptions of the components, modules, and systems of a product or service. The engineering models 824 may be configured to, when executed, generate evidence that may satisfy a certification goal 202. In one example, the engineering model 824 contains a numerical representation of the connections between electronic components in a product. When executed, the engineering model may be configured to determine the reaction of various components in a product when one electronic component is activated. The reaction may be quantified numerically and transmitted to the database 822 as evidence.

The engineering models 824 can be linked automatically to certification goals 202 by the AI system. A knowledge graph or other classifier can be used to identify the parts of an engineering model that correspond to a specific certification goal 202. The system can derive interdependencies between certification goals 202 and model elements by analyzing the relationships within the knowledge graph.

The system can execute the engineering models 824 to determine the status of one or more certification arguments. When a model indicates that a certification goal 202 is not met, the system can propose modifications to the model that would satisfy the goal. The proposed modifications can include changes to a single parameter or to multiple parameters. The system can also determine a range of values for one or more parts that would meet all applicable certifications.

The disclosed system allows informed decisions in projects where strict compliance may conflict with other design constraints. For instance, the system includes the capability to determine both fully compliant and partially compliant ranges such that a range of modifications that would satisfy most certifications but not all. That range can be presented to a user so that design trade-offs can be evaluated.

The certification client device 808 provides users with the ability to build a certification argument, assess a certification argument, visualize a certification argument, and effectuate regulatory submissions. The certification client device 808 may be a single computing device, a co-located computing device, a cloud computing device, or the like. The certification client device 808 may include an input 830, a graphing component 832, and a display 834.

The input 830 allows a user to interact with the certification management server 804. Various forms of input include, but are not limited to a computer mouse, a keyboard, a touch screen, a joystick, and control pad, a remote control, and a motion sensing device. Various elements of the certification argument may be entered into the certification argument with the input. For example, a user may use a mouse to select a context and a keyboard to add a certification goal to the context of a certification argument.

The input 830 can be used to direct the certification management system 800 to focus on certification for one or more parts. A user can specify a part and a change to that part, and the system can determine the effect of the change on the associated certification goals 202 and related certifications. The input 830 can also be used for human-in-the-loop review of the certification process. For example, a user with detailed knowledge of the product can request a concise printout of the certification goals 202 along with the associated engineering models 824. The system can generate and provide the requested output so the user can confirm that the system is evaluating the certifications correctly.

The graphing component 832 presents various aspects of the certification argument visually on a display 834. In an exemplary embodiment, the graphing component 832 may represent the elements of a certification argument and their relationships to one another similarly to the elements shown in FIG. 2. The graphing component 832 may also be configured to display the various components and/or modules of engineering models 824. The graphing component 832 may be configured to allow a user to select, with the input 830, elements of a certification argument for addition, modification, and inspection of elements. A user may employ the graphing component 832 to inspect, modify, or construct engineering models 824.

The graphing component 832 can visually present certification goals 202, evidence 204, rationale 206, tasks, and context 210 along with the relationships between them. It can also display results from engineering models 824 showing ranges of values for one or more parts. Those ranges can include values that result in full certification for the part and all related parts, and values that result in certification for some parts but not all. The visualization can distinguish between passing and failing conditions so that the user can evaluate the impact of proposed changes. The graphing component 832 can update the display dynamically as the certification management system 800 processes new data or applies modifications to the certification argument.

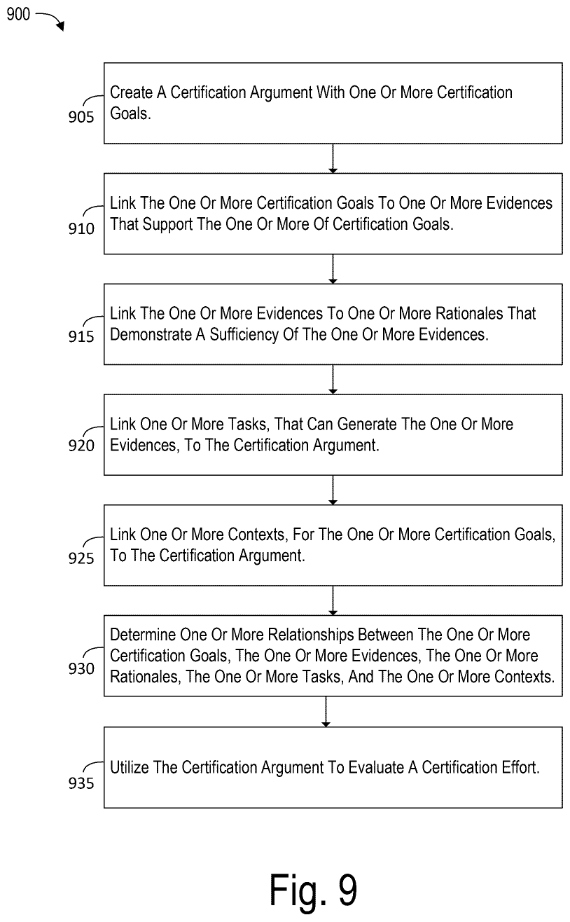

Referring to FIG. 9, FIG. 9 is a flow diagram of a computer implemented method 900 to certify a product or service. The method 900 may be used to verify that a product or service is certified. Additionally, the method 900 may be used as part of a process to create regulatory submission documents. At step 905, the method 900 may create a certification argument with one or more certification goals 202. The certification goals 202 may be conditions for which the certification goal is satisfied when the condition is met. In an exemplary embodiment, the certification goals are associated with regulations. Each certification goal may be presented as an objective to satisfy a regulation. For example, a regulation for a warning to be activated when a pressure exceeds a maximum value may be presented as a certification goal.

At step 910, the method 900 may link the one or more certification goals to one or more evidences 204 that support the one or more certification goals. The evidences 204 may be data that describes how the certification goal is met. In an exemplary embodiment, the one or more evidences 204 are generated numerically as an engineering model 824 is executed. In an example of the exemplary embodiment, the engineering model 824 may describe the connections of various electrical components in a product. When the engineering model 824 is executed, the numerical output of the engineering model 824 may indicate that an electrical component operates correctly or incorrectly in response to the operation of another electrical component. The output may be the evidence 204 that supports the certification goal 202.

At step 915, the method 900 may link the one or more evidences to one or more rationales 206 that demonstrate a sufficiency of the one or more evidences 204. In various embodiments, the rationales 206 may be conditional statements that accept numerical values from the evidences 204 as input. When the conditional statement is met, the sufficiency of the certification goal 202, to which the rationale 206 is linked, is demonstrated by the rationale 206. In an example of an exemplary embodiment, the rationale 206 is a statement of the regulatory criteria of the linked certification goal 202 that is converted into a conditional statement and accepts evidence 204 as input. In an implementation of the example, a certification goal 202 that a liquid be above a minimum temperature may be restated as a computer readable comparative condition that is true if the temperature is above the minimum value. The computer readable comparative condition is the rationale 206 and the temperature would be the evidence 204.

At step 920, the method 900 may link one or more tasks that can generate the one or more evidences 204, to the certification argument. The tasks may be scheduled by plans 208 to generate the evidences 204. In an exemplary embodiment, the task directs an engineering model 824 to be executed. The engineering model 824 may be configured to generate evidence in numerical form when the engineering model 824 is executed.

At step 925, the method 900 may link one or more contexts 210 for the one or more certification goals 202, to the certification argument. The contexts 210 may represent a hierarchy that organizes the one or more certification goals 202 in relation to other certification goals 202. New certification goals 202 that are added to the certification argument may be placed in the certification argument according to the context 210 that is determined for the certification goal 202. An example of a context 210 for a certification goal 202 that regulates the connection of electrical components in a product would be an “electrical system” context 210. Certification goals 202 that may be added to the certification argument with the “electrical system” context 210 could be easily associated with other certification goals 202 with the same or similar context 210. The relationship between contexts 210 may determine the relationship between the certification goals 202 associated with the contexts 210. For example, if a first context is determined to be dependent on a second context, the certification goal associated with the first context may be similarly determined to be depended on the certification goal associated with the second context.

At step 930, the method 900 may determine one or more relationships between the one or more certification goals 202, the one or more evidences 204, the one or more rationales 206, the one or more tasks, and the one or more contexts 210. In various embodiments, the relationships may be determined by assessing the contexts 210, which may define a hierarchy of various contexts 210. Relationships may be determined between contexts 210 that have a hierarchal connection between one another. For example, a communication system context 210 may be dependent on an electrical system context 210. A dependent relationship may be thus determined for the communication system context 210 in relation to the electrical system context 210. Based on the contexts 210, the relationship associated certification goals 202 may be similarly determined. For the previous example, a certification goal 202 that is associated with the communication system context 210 may be determined to have a dependent relationship to a certification goal that is associated with the electrical system context 210. The relationships between evidences 204, rationales 206 and tasks may be similarly determined based on the context 210 with which they are respectively associated.

At step 935, the method 900 may utilize the certification argument to evaluate a certification effort. A certification effort may be a summation of all certification goals in a certification argument. In various embodiments, the rationales 206 are computer readable conditional statements. The certification argument assessment component 812 may evaluate the rationales 206 to determine the status of the various certification goals of the certification argument. The method may indicate the status of a product or service as satisfactory or not satisfactory by activating a communicative message that is understandable by a user to be the certification status of the product or service. For example, a display may indicate the words “satisfied” or “not satisfied” to indicate the certification status of the product or service. In another example, the method 900 may generate a regulatory submission document that indicates the certification status of the product or service on a document that is printed or in digital format.

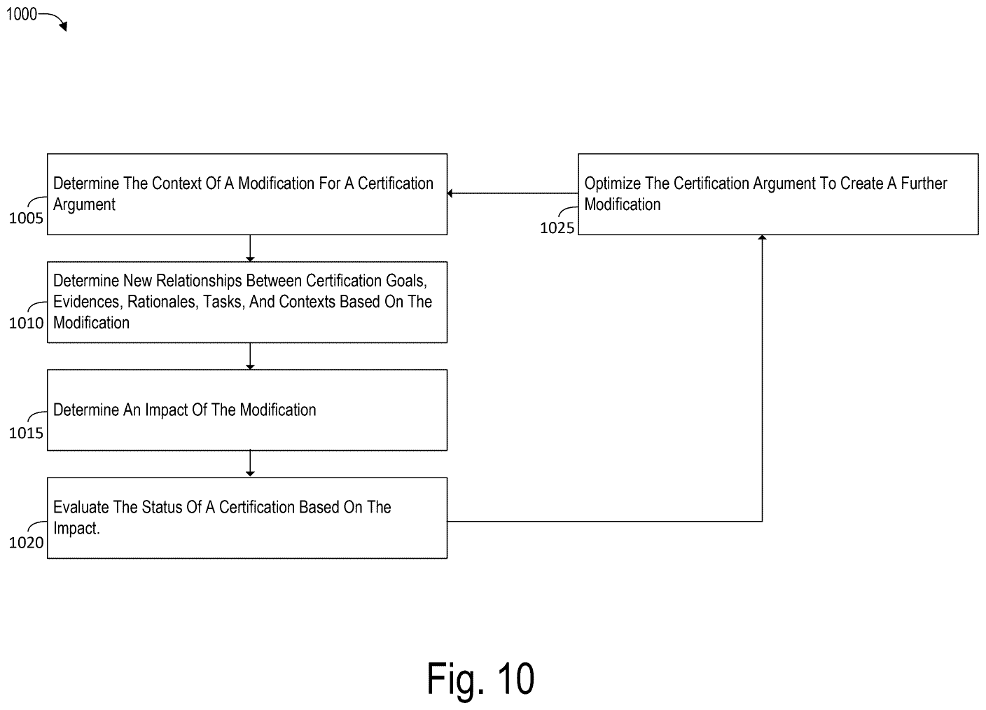

Referring to FIG. 10, FIG. 10 is a flow diagram of a process 1000 to modify a certification argument in the certification management system. The certification argument may be modified continuously as regulations are changed and/or the product or service that is being regulated is changed. The act of building a certification argument may be considered a modification as every certification goal, context, rationale, and task is added or changed. After some modifications, it may be valuable to determine an impact of the modification on the certification argument. The impact of a modification of a certification goal 202 may or may not influence other certification goals. Similarly, the impact of a modification of an evidence 204 element may have an impact on various certification goals. The certification management system may be configured to quickly determine the impact, be it small or large, of various modifications, which may aid in a certification effort.

At step 1005, the certification management system may determine the context 210 of a modification for a certification argument. The context 210 of a modification may specify a hierarchy of the relationship a modification has with various elements of a certification argument. For example, a modification that adds a regulation to the sound of a product may be determined to have a sound system context 210. Based on the context 210, a certification goal 202 of the modification may inherit the sound system context 210.

A modification may effect a change in the relationships between various elements of the certification argument. At step 1010, the certification management system may determine new relationships between certification goals, evidences, rationales, tasks, and contexts based on the modification. Using the previous example of a modification with a sound system context 210, a relationship may be determined for the certification goal 202 of the modification based on the sound system context 210. In the example, a certification goal 202 with a communication system context 210 may be determined to have a dependent relationship with the certification goal 202 with the sound system context 210. Similarly, relationships between evidences, rationales, and tasks may be determined. In various embodiments, elements may be further modified based on their similarity of the modification. For example, an evidence element that is added to a certification argument in a modification may be the same as another evidence element that is already in the certification argument. The two evidence 204 elements may be combined into one evidence 204. Similarly, multiple tasks to generate the same evidence 204 may be combined into a single task.

At step 1015, the certification management system may determine an impact of the modification. The newly determined relationships between various elements of the certification argument may change the result of a certification effort. At step 1020, the certification management system may evaluate the status of a certification based on the impact. The status of certification goals 202 of the certification argument may be determined by evaluating the rationales 206 associated with the certification goals 202. In an exemplary embodiment, the rationales 206 may execute tasks that generate new evidence 204 after every modification. For example, a task may execute an engineering model 824 to generate evidence as a result of a modification. The evaluation of the rationales 206 may determine the status of the various certification goals 202 in the certification argument, which together may determine the impact of the modification.

At step 1025, the certification management system may optimize the certification argument to create a further modification. For example, based on the relationships that were determined from the modification, some elements of the certification argument may overlap or be the same. Overlapping or similar elements of the certification argument may be combined or eliminated to simplify the certification argument. In various embodiments, the simplification of the certification argument may result in a reduction in costs of the certification effort. The optimization of the certification argument may result in a further modification. The impact of the further optimization may be determined by iterating over the process 1000 again.

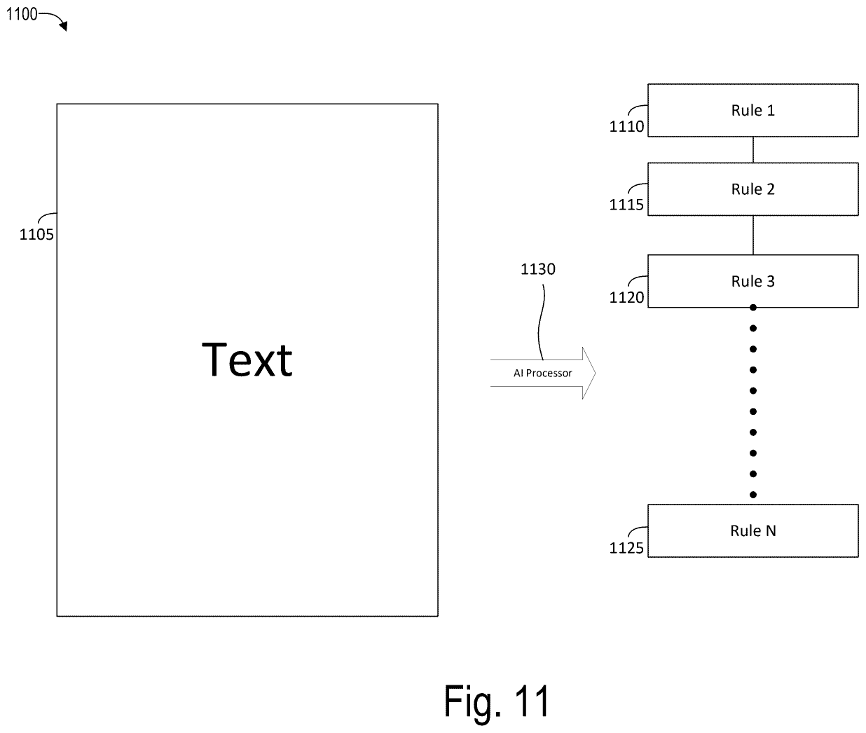

Referring to FIG. 11, FIG. 11 is an illustration 1100 of an AI processor processing a source document into a format that is AI-readable. In one embodiment, the AI processor may parse the source document to identify one or more portions of content, such as headings, paragraphs, tables, or figures, and convert those portions into a structured representation. The structured representation may include tags, identifiers, or metadata that characterize the meaning, context, and relationships of the extracted content.

As shown in the illustration 1100, the process begins with the unstructured text 1105. The unstructured text 1105 is processed by the AI processor 1130, which converts the unstructured text 1105 into individual rules such as rule 1 1110, rule 2 1115, rule 3 1120, and so on, up to rule N 1125.

The AI processor may further normalize the content into a consistent vocabulary or ontology, such that different expressions of the same concept are mapped to a common representation. In some cases, the AI processor may resolve ambiguities by referencing one or more external knowledge bases, rule sets, or training models. The output of this process may be stored in a structured format, such as JSON, XML, or a proprietary schema, enabling subsequent automated reasoning, comparison, or certification analysis by other system components.

In certain embodiments, the AI-processed, structured representation may be linked to certification arguments, evidences, or rationales stored within the system, allowing the structured content to be directly utilized in creating, modifying, or evaluating certification efforts.

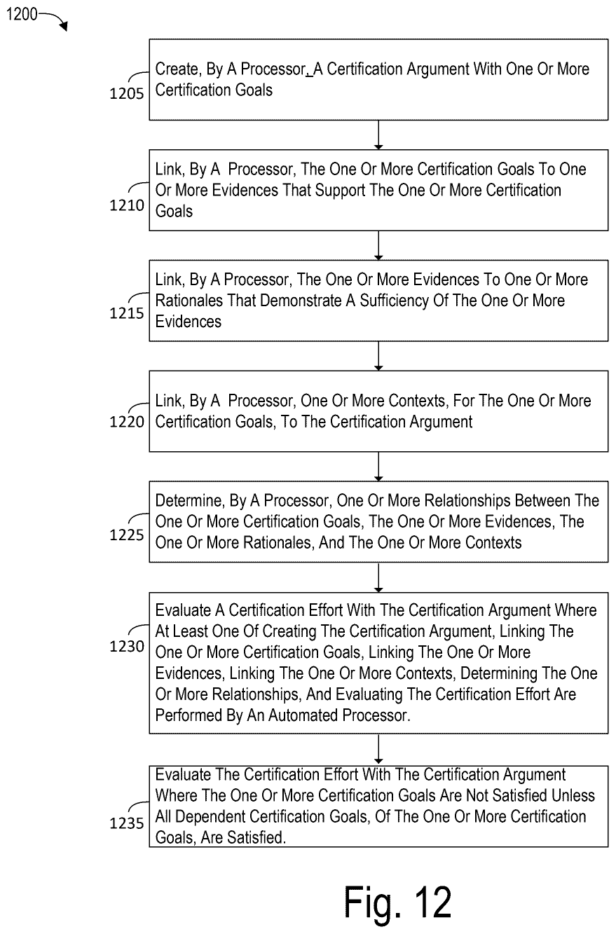

Referring to FIG. 12, FIG. 12 is a flow diagram 1200 of a process for certifying a product or service. The diagram shows how the system generates a certification argument, links that argument to evidence and rationales, associates contexts, determines relationships, and evaluates a certification effort. The process can operate in a fully automated mode or with human review.

At step 1205, the system creates a certification argument that includes one or more certification goals. In an embodiment, this can be performed by an automated processor. For example, the automated processor can analyze engineering documents and automatically define a goal, such as making sure that a specific component of an aircraft wing meets certain safety criteria. For instance, the automated system can parse the input documents and generate goals directly without human intervention.

At step 1210, the system links, by a processor, the one or more certification goals to one or more evidences that support the one or more certification goals. For example, an automated processor can scan a repository of engineering documents and identify relevant pieces of evidence, such as test reports or compliance documents. Each certification goal may be directly associated with the evidence that supports it. In one embodiment, an AI processor performs the linking automatically to match goals and evidence.

At step 1215, the system links, by a processor, the one or more evidences to one or more rationales that demonstrate a sufficiency of the one or more evidences. The one or more evidences may include, for example, test results, inspection reports, simulation data, engineering analyses, or compliance documents. The one or more rationales may include logical explanations, regulatory interpretations, engineering judgments, or mathematical derivations that support or relate to the evidences.

The demonstrated sufficiency of the one or more evidences can be accomplished in various ways, such as when the evidences meet the requirements of one or more certification goals. For example, a stress test report may be linked to an engineering analysis that explains how the measured stress values correspond to a threshold in a relevant regulatory standard. In this case, the rationale ties the test data to a standard in a manner that supports the certification argument.

In one embodiment, an automated processor performs the linking of evidences to rationales. The processor may parse documents to extract evidences, identify corresponding rationales using classifiers or semantic matching, and store the linked pairs in a structured database.

At step 1220, the system may link, by a processor, one or more contexts for the one or more certification goals to the certification argument. The one or more contexts may include any information, rule set, environmental condition, or operational parameter relevant to interpreting or evaluating a certification goal. The contexts may be expressed in a form interpretable by the system, such as structured data, parsed text, or semantic representations derived from unstructured sources.

For example, a context may include regulatory clauses applicable to a component, engineering tolerances for a mechanical part, or performance specifications from an industry standard. The linking of these contexts to the certification argument may provide traceability and clarity as to how each certification goal is grounded in specific operational, regulatory, or technical circumstances.

In one embodiment, the linking may be performed automatically by a processor using a knowledge graph, topic modeling, natural language processing, or other AI techniques. Accordingly, a fully or partially automated system can associate each certification goal with one or more contexts identified from a repository of rules, standards, or other domain knowledge. The processor may then map the linked contexts directly into the certification argument.

At step 1225, the system may determine, by a processor, one or more relationships between the one or more certification goals, the one or more evidences, the one or more rationales, and the one or more contexts. The relationships may include direct associations, dependencies, or indirect linkages identified through automated or semi-automated analysis. The relationships may be logical, functional, temporal, or based on compliance rules, engineering dependencies, or operational constraints.

For example, a certification goal may be related to a specific piece of evidence through a rationale that connects the evidence to the required outcome. The same goal may also be linked to one or more contexts that define the operating or regulatory conditions in which the goal must be met. The processor may identify that a particular context, such as an environmental operating temperature range, applies to multiple certification goals and thereby establish a relationship between those goals.

In one embodiment, the relationships may be determined automatically using AI-based techniques such as knowledge graph traversal, similarity scoring, rule-based inference, or machine learning classifiers. The system may identify that certain evidences satisfy multiple goals, that certain rationales apply across several evidences, or that a change in context for one goal could affect related goals. This automated relationship mapping may be used to maintain a dynamically updated certification argument. Accordingly, the system quickly adapts to changes in evidence, rationales, or contexts.

At step 1230, the system may evaluate a certification effort with the certification argument where at least one of creating the certification argument, linking the one or more certification goals, linking the one or more evidences, linking the one or more contexts, determining the one or more relationships, or evaluating the certification effort are performed by an automated processor. The evaluation may include verifying that the certification goals themselves are met, evaluating the one or more evidences linked to those goals, evaluating the evidences in light of the rationales to which they are linked, and evaluating any dependencies the certification goals have on other certification goals. One or more parts of the evaluation may be automated or performed by an automated processor. The certification argument may be created through an automated process. For example, linking the one or more certification goals may be automatically performed without manual intervention. The evidences may be linked to the certification goals without manual intervention by an automated process. The relationships may also be determined by an automated process without manual intervention.

In an exemplary embodiment, all steps of evaluating the certification effort are performed by an automated process without manual intervention. In another exemplary embodiment, an individual step of evaluating the certification effort is performed manually, and the rest of the evaluation is performed by an automated process. For example, an individual may manually link an evidence to a certification goal to modify one portion of the certification argument, and the rest of the evaluation may be performed automatically after the manual change.

In some embodiments, the evaluation may be performed automatically by a processor using logical rules, dependency graphs, or AI-based inference engines. The system may simulate the certification argument with dependency constraints applied, providing the user with a report that identifies which goals are blocked, the reasons for blocking, and what additional evidence or rationales are required. The evaluation may also include predictive analysis to estimate the likelihood of satisfying blocked goals based on current evidence, linked rationales, and known contexts.

At step 1235, the system may evaluate the certification effort with the certification argument where the one or more certification goals are not satisfied unless all dependent certification goals, of the one or more certification goals, are satisfied. The dependencies may be identified in advance, derived from regulatory rules, or determined dynamically based on relationships between goals, evidences, rationales, and contexts.

For example, a system evaluating the certification of a component may determine that the component's operational safety goal is dependent on an environmental durability goal being satisfied first. If the environmental durability goal is not met, the system may halt evaluation or mark the operational safety goal as pending. The evaluation may also include examining whether the evidence supporting the operational safety goal aligns with its rationale and whether that rationale remains valid in the current context. This example can be extended to any number of dependencies. For example, a certification goal may have hundred of dependencies.

Exemplary embodiments disclose a method, a computer program product, and a computer system for managing certification efforts for obtaining regulatory approvals for products. Exemplary embodiments use the certification argument framework to structure complex certification efforts and build a database of related information. The certification argument framework also provides effective means of graphically representing and analyzing regulatory certification efforts.

In various embodiments, a computer-implemented method to manage certification of a product or a service includes creating a certification argument with one or more certification goals and linking the one or more certification goals to one or more evidences that support the one or more certification goals. The computer-implemented method includes linking the one or more evidences to one or more rationales that demonstrate a sufficiency of the one or more evidences and linking one or more tasks, that can generate the one or more evidences, to the certification argument. The computer-implemented method includes linking one or more contexts, for the one or more certification goals, to the certification argument. The computer-implemented method includes determining one or more relationships between the one or more certification goals, the one or more evidences, the one or more rationales, the one or more tasks, and the one or more contexts and utilizing the certification argument to evaluate a certification effort. The computer-implemented method may further include generating a formatted display of the certification argument. The computer-implemented method may further include tracking approvals of the one or more certification goals in the certification argument. The computer-implemented method may further include assembling one or more engineering models that represent elements of the product or service and executing the one or more engineering models to generate one or more evidences. The computer-implemented method may further include generating a regulatory submission document with the certification argument. The computer-implemented method may further include generating a notification responsive to a change in the certification argument where one or more recipients, for which the notification is directed, are selected based on the one or more relationships. The computer-implemented method may further include modifying the one or more tasks and their relationships in the certification argument to optimize costs of certification.

An exemplary embodiment includes a computer-program product to manage certification of a product or a service. The computer program product includes one or more non-transitory computer-readable storage media and program instructions stored on the one or more non-transitory computer-readable storage media capable of performing a method. The method includes creating a certification argument with one or more certification goals. The method includes linking the one or more certification goals to one or more evidences that support the one or more certification goals and linking the one or more evidences to one or more rationales that demonstrate a sufficiency of the one or more evidences. The method includes linking one or more tasks that can generate the one or more evidences to the certification argument and linking one or more contexts for the one or more certification goals to the certification argument. The method includes determining one or more relationships between the one or more certification goals, the one or more evidences, the one or more rationales, the one or more tasks, and the one or more contexts and utilizing the certification argument to evaluate a certification effort. The method may further include generating a formatted display of the certification argument. The method may further include tracking approvals of the one or more certification goals in the certification argument. The method may further include assembling one or more engineering models that represent elements of the product or service and executing the one or more engineering models to generate one or more evidences. The method may further include generating a regulatory submission document with the certification argument. The method may further include generating a notification responsive to a change in the certification argument where one or more recipients, for which the notification is directed, are selected based on the one or more relationships. The method may further include modifying the one or more tasks and their relationships in the certification argument to optimize costs of certification.

Another general aspect is a computer system to manage a product or service certification. The computer system includes one or more processors, one or more computer-readable storage media, and program instructions stored on one or more of the computer-readable storage media for execution by one or more processors configured to link the one or more certification goals to one or more evidences that support the one or more of certification goals. The at least one of the one or more processors are further configured to link the one or more evidences to one or more rationales that demonstrate a sufficiency of the one or more evidences. The at least one of the one or more processors are further configured to link one or more tasks that can generate the one or more evidences to the certification argument and link one or more contexts for the one or more certification goals to the certification argument. The at least one of the one or more processors are further configured to determine one or more relationships between the one or more certification goals, the one or more evidences, the one or more rationales, the one or more tasks, and the one or more contexts and utilize the certification argument to evaluate a certification effort. The at least one of the one or more processors may be further configured to utilize the certification argument to evaluate a certification effort. The at least one of the one or more processors may be further configured to generate a formatted display of the certification argument. The at least one of the one or more processors may be further configured to track approvals of the one or more certification goals in the certification argument. The at least one of the one or more processors may be further configured to assemble one or more engineering models that represent elements of the product or service and executing the one or more engineering models to generate one or more evidences. The at least one of the one or more processors may be further configured to generate a regulatory submission document with the certification argument. The at least one of the one or more processors may be further configured to generate a notification responsive to a change in the certification argument where one or more recipients, for which the notification is directed, are selected based on the one or more relationships.

A computer-implemented method to manage certification of a product or a service includes creating, by a processor, a certification argument with one or more certification goals; linking, by a processor, the one or more certification goals to one or more evidences that support the one or more certification goals; linking, by a processor, the one or more evidences to one or more rationales that demonstrate a sufficiency of the one or more evidences; linking, by a processor, one or more contexts, for the one or more certification goals, to the certification argument; determining, by a processor, one or more relationships between the one or more certification goals, the one or more evidences, the one or more rationales, and the one or more contexts; and evaluating a certification effort with the certification argument where at least one of creating the certification argument, linking the one or more certification goals, linking the one or more evidences, linking the one or more contexts, determining the one or more relationships, and evaluating the certification argument by an automated processor. The one or more certification goals may not be satisfied unless all dependent certification goals, of the one or more certification goals, are satisfied. The method may further include identifying at least one of the one or more certification goals, evidences, rationales, or contexts by an automated processor. The method may further include linking, by a processor, one or more tasks that can generate the one or more evidences to the certification argument. The method may further include generating the certification argument in Systems Modeling Language (SysML) or Unified Modeling Language (UML) format and generating a formatted display of the certification argument. The method may further include tracking, by an automated processor, approvals of the one or more certification goals in the certification argument. The method may further include assembling one or more engineering models that represent elements of the product or service and executing the one or more engineering models to generate one or more evidences. The method may further include determining, using one or more engineering models, a range of product specifications that will satisfy one or more certification goals of the certification argument. The method may further include generating a regulatory submission document with the certification argument. The method may further include generating a notification responsive to a change in the certification argument and selecting one or more recipients, for which the notification is directed, based on the one or more relationships. The method may further include modifying the one or more tasks and their relationships in the certification argument to optimize costs of certification.

A computer-program product to manage certification of a product or a service includes one or more non-transitory computer-readable storage media and program instructions stored on the one or more non-transitory computer-readable storage media capable of performing a method. The method includes creating, by a processor, a certification argument with one or more certification goals; linking, by a processor, the one or more certification goals to one or more evidences that support the one or more certification goals; linking, by a processor, the one or more evidences to one or more rationales that demonstrate a sufficiency of the one or more evidences; linking, by a processor, one or more contexts, for the one or more certification goals, to the certification argument; determining, by a processor, one or more relationships between the one or more certification goals, the one or more evidences, the one or more rationales, and the one or more contexts; and evaluating a certification effort with the certification argument where at least one of creating the certification argument, linking the one or more certification goals, linking the one or more evidences, linking the one or more contexts, determining the one or more relationships, and evaluation the certification effort are performed by an automated processor. The one or more certification goals may not be satisfied unless all dependent certification goals, of the one or more certification goals, are satisfied. The computer-program product may further include identifying at least one of the one or more certification goals, evidence, rationales, or contexts by an automated processor. The computer-program product may further include linking, by a processor, one or more tasks that can generate the one or more evidences to the certification argument. The computer-program product may further include generating a regulatory submission document with the certification argument; generating a notification responsive to a change in the certification argument; and selecting one or more recipients for the notification based on the one or more relationships.

A computer system to manage certification of a product or service includes one or more processors, one or more computer-readable storage media, and program instructions stored on one or more of the computer-readable storage media for execution by one or more processors configured to create a certification argument with one or more certification goals; link the one or more certification goals to one or more evidences that support the one or more certification goals; link the one or more evidences to one or more rationales that demonstrate a sufficiency of the one or more evidences; link one or more contexts, for the one or more certification goals, to the certification argument; determine one or more relationships between the one or more certification goals, the one or more evidences, the one or more rationales, and the one or more contexts; and evaluate a certification effort with the certification argument where the one or more certification goals are enjoined from certification unless related certification goals, for which they are dependent, are satisfied. The system may include performing at least one of the creating, linking, determining, or evaluating by an automated processor, and may include identifying one or more certification goals, evidences, rationales, or contexts by the automated processor. The system may further include linking, by a processor, one or more tasks that can generate the one or more evidences for the certification argument; generating the certification arguments in Systems Modeling Language (SysML) or Unified Modeling Language (UML) format; and tracking approvals of the one or more certification goals in the certification argument. The system may further include assembling one or more engineering models that represent elements of the product or service; executing the one or more engineering models to generate one or more evidences; determining, using the one or more engineering models, a range of product specifications that will satisfy one or more certification goals of the certification argument; generating a regulatory submission document with the certification argument; generating a notification responsive to a change in the certification argument; and selecting one or more recipients for the notification based on the one or more relationships.

The programs described herein are identified based upon the application for which they are implemented in a specific embodiment of the disclosed subject matter. However, it should be appreciated that any particular program nomenclature herein is used merely for convenience, and thus the disclosed subject matter should not be limited to use solely in any specific application identified and/or implied by such nomenclature.

Based on the foregoing, a computer system, method, and computer program product have been disclosed. However, numerous modifications and substitutions can be made without deviating from the scope of the disclosed subject matter. Therefore, the disclosed subject matter has been disclosed by way of example and not limitation.

It is to be understood that teachings recited herein are not limited to a computing environment. Instead, embodiments of the disclosed subject matter can be implemented in conjunction with any other type of computing environment now known or later developed.

Detailed embodiments of the claimed structures and methods are disclosed; however, it can be understood that they are merely illustrative of the claimed structures and methods that may be embodied in various forms. However, the disclosed subject matter may be embodied in many different forms and should not be construed as limited to the exemplary embodiments set forth herein. Instead, these exemplary embodiments are provided so that this disclosure will be thorough and complete, and will fully convey the scope of the disclosed subject matter to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of embodiments of the disclosed subject matter, in the detailed description above, some processing steps or operations that are known in the art may have been combined together for presentation and for illustration purposes and in some instances may have not been described in detail. In other instances, some processing steps or operations that are known in the art may not be described at all.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

What is claimed is:

1. A computer-implemented method to manage certification of a product or a service, the method comprising:
creating, by a processor, a certification argument with one or more certification goals;
linking, by a processor, the one or more certification goals to one or more evidences that support the one or more certification goals;
linking, by a processor, the one or more evidences to one or more rationales that demonstrate a sufficiency of the one or more evidences;
linking, by a processor, one or more contexts, for the one or more certification goals, to the certification argument;
determining, by a processor, one or more relationships between the one or more certification goals, the one or more evidences, the one or more rationales, and the one or more contexts; and
evaluating, by a processor, a certification effort with the certification argument where at least one of creating the certification argument, linking the one or more certification goals, linking the one or more evidences, linking the one or more contexts, determining the one or more relationships, and evaluating the certification effort are performed by an automated processor.

2. The computer-implemented method of claim 1, wherein the one or more certification goals are not satisfied unless all dependent certification goals, of the one or more certification goals, are satisfied.

3. The computer-implemented method of claim 1, further comprising identifying at least one of the one or more certification goals, evidences, rationales, or contexts by an automated processor.

4. The computer-implemented method of claim 1, further comprising linking, by a processor, one or more tasks, that can generate the one or more evidences, to the certification argument.

5. The computer-implemented method of claim 1, further comprising generating the certification arguments in Systems Modeling Language (SysML) or Unified Modeling Language (UML) format.

6. The computer-implemented method of claim 1, further comprising:
tracking by an automated processor, approvals of the one or more certification goals in the certification argument.

7. The computer-implemented method of claim 1, further comprising:
assembling one or more engineering models that represent elements of the product or service and executing the one or more engineering models to generate one or more evidences.

8. The computer-implemented method of claim 7, further comprising determining, using one or more engineering models, a range of product specifications that will satisfy one or more certification goals of the certification argument.

9. The computer-implemented method of claim 1, further comprising:
generating a regulatory submission document with the certification argument.

10. The computer-implemented method of claim 1, further comprising:
generating a notification responsive to a change in the certification argument; and
wherein one or more recipients, for which the notification is directed, are selected based on the one or more relationships.

11. The computer-implemented method of claim 4, further comprising:
modifying the one or more tasks and their relationships in the certification argument to optimize costs of certification.

12. A computer-program product to manage certification of a product or a service, the computer-program product comprising:
one or more non-transitory computer-readable storage media and program instructions stored on the one or more non-transitory computer-readable storage media capable of performing a method, the method comprising:
creating, by a processor, a certification argument with one or more certification goals;
linking, by a processor, the one or more certification goals to one or more evidences that support the one or more certification goals;
linking, by a processor, the one or more evidences to one or more rationales that demonstrate a sufficiency of the one or more evidences;
linking, by a processor, one or more contexts, for the one or more certification goals, to the certification argument;
determining, by a processor, one or more relationships between the one or more certification goals, the one or more evidences, the one or more rationales, and the one or more contexts; and
evaluating a certification effort with the certification argument wherein the one or more certification goals are not satisfied unless all dependent certification goals, of the one or more certification goals, are satisfied.

13. The computer-program product of claim 12, wherein at least one of the creating the certification argument, linking the one or more certification goals, linking the one or more evidences, linking the one or more contexts, determining the one or more relationships, and evaluating the certification argument are performed by an automated processor.

14. The computer-program product of claim 13, further comprising identifying at least one of the one or more certification goals, evidences, rationales, or contexts by an automated processor.

15. The computer-program product of claim 12, further comprising linking, by a processor, one or more tasks, that can generate the one or more evidences, to the certification argument.

16. The computer-program product of claim 12, further comprising:
generating a regulatory submission document with the certification argument;
generating a notification responsive to a change in the certification argument; and
selecting one or more recipients for the notification based on the one or more relationships.

17. A computer system to manage certification of a product or service, the computer system comprising:
one or more processors, one or more computer-readable storage media, and program instructions stored on one or more of the computer-readable storage media for execution by one or more processors configured to:
create a certification argument with one or more certification goals;
link the one or more certification goals to one or more evidences that support the one or more certification goals;
link the one or more evidences to one or more rationales that demonstrate a sufficiency of the one or more evidences;
link one or more contexts, for the one or more certification goals, to the certification argument;
determine one or more relationships between the one or more certification goals, the one or more evidences, the one or more rationales, and the one or more contexts; and
evaluate a certification effort with the certification argument where at least one of create the certification argument, link the one or more certification goals, link the one or more evidences, linking the one or more contexts, determine the one or more relationships, and evaluate the certification effort are performed by an automated processor.

18. The computer system of claim 17, wherein the one or more certification goals are not satisfied unless all dependent certification goals, of the one or more certification goals, are satisfied.

19. The computer system of claim 17, further comprising linking, by a processor, one or more tasks that can generate the one or more evidences to the certification argument;
generating the certification arguments in Systems Modeling Language (SysML) or Unified Modeling Language (UML) format; and
tracking approvals of the one or more certification goals in the certification argument.

20. The computer system of claim 17, further comprising assembling one or more engineering models that represent elements of the product or service;
executing the one or more engineering models to generate one or more evidences;
determining, using the one or more engineering models, a range of product specifications that will satisfy one or more certification goals of the certification argument; generating a regulatory submission document with the certification argument;
generating a notification responsive to a change in the certification argument; and
selecting one or more recipients for the notification based on the one or more relationships.
